(19) United States
(12) Patent Application Publication
(10) Pub. No.: US 2006/0136527 A1
(43) Pub. Date: Jun. 22, 2006

(54) Determining the target readership of a document

(76) Inventors: Donata Ducati, Heidelberg (DE); Matthias Kammerer, Karlsruhe (DE)

Correspondence Address: FISH & RICHARDSON, P.C., PO BOX 1022, MINNEAPOLIS, MN, 55440-1022, US

(21) Appl. No.: 11/021,254

(22) Filed: Dec. 21, 2004

(51) Int. Cl. G06F 17/30; G06F 12/00

(52) U.S. Cl. 707/205

(57) ABSTRACT

Systems, methods, apparatus, and computer program products, for determining the target readership of a document. The techniques include receiving from a profiling tool a profiled document, the profiling tool being a tool that receives a source document and a readership profile and applies the readership profile to the source document to generate a profiled document, the readership profile specifying one or more target readerships, the source document including one or more portions of readership-specific content, the profiled document including only those portions of readership-specific content that are specific to any of the target readerships; determining whether more than one target readership has been specified in the readership profile; and if more than one target readership has been specified, marking each portion of readership-specific content to identify the readership to which the content is specific, and if only one target readership has been specified, not marking any portion of readership-specific content.

### BACKGROUND

The present invention relates to data processing by digital computer, and more particularly to generating documents.

A document can contain content that is specific to a particular target readership. This content can be marked with an indication of the target readership. For example, a user manual for a computer system can include content that is specific to readers using the Windows operating system and other content that is specific to readers using the Unix operating system.

### SUMMARY OF THE INVENTION

The present invention provides systems, methods, apparatus, and computer program products, for determining the target readership of a document.

In one general aspect, the invention provides a system that comprises a profiling tool and a marking tool. The profiling tool is operable to receive a source document and a readership profile, and apply the readership profile to the source document to generate a profiled document. The readership profile specifies one or more target readerships, the source document includes one or more portions of readership-specific content that is specific to a particular readership. The profiled document includes only those portions of readership-specific content that is specific to any of the target readerships. The marking tool is operable to receive the profiled document from the profiling tool, determine whether more than one target readership has been specified in the readership profile, and if more than one target readership has been specified, mark each portion of readership-specific content in the profiled document to identify the readership to which the content is specific, and if only one target readership has been specified, not mark any portion of readership-specific content in the profiled document.

Implementations can include one or more of the following features:

The profiling tool generates the profiled document by filtering out those portions of readership-specific content in the source document that are not specific to any of the target readerships specified in the readership profile.

Associated with the profile document is an attachment that lists each target readership specified in the readership profile. The marking tool determines whether more than one target readership has been specified in the readership profile by using the attachment to make the determination.

The marking tool determines whether more than one target readership has been specified in the readership profile by retrieving a log file generated by the profiling tool and using the log file to make the determination. The log file includes information that identifies the target readerships specified in the readership profile.

The profiled document is an XML (extensible markup language) document.

The output document is an HTML (hypertext markup language) or PDF (portable document format) document.

The profiling tool is part of a document editing program; and the marking tool is part of a document rendering program.

The document editing program is an XML (extensible markup language) text editor and the document rendering program is an XSL (extensible stylesheet language) transformation program.

In another general aspect, the invention provides a computer program product that is operable to cause data processing apparatus to perform operations comprising:

receiving from a profiling tool a profiled document, the profiling tool being a tool that receives a source document and a readership profile and applies the readership profile to the source document to generate a profiled document, the readership profile specifying one or more target readerships, the source document including one or more portions of readership-specific content that is specific to a particular readership, the profiled document including only those portions of readership-specific content that is specific to any of the target readerships specified in the readership profile;

determining whether more than one target readership has been specified in the readership profile; and

if more than one target readership has been specified, marking each portion of readership-specific content in the profiled document to identify the readership to which the content is specific, and if only one target readership has been specified, not marking any portion of readership-specific content in the profiled document.

Implementations can include one or more of the following features:

Associated with the profile document is an attachment that lists each target readership specified in the readership profile. Determining whether more than one target readership has been specified in the readership profile includes using the attachment to make the determination.

Determining whether more than one target readership has been specified in the readership profile includes retrieving a log file generated by the profiling tool, the log file including information that identifies the target readerships specified in the readership profile, and using the log file to make the determination.

The profiled document is an XML (extensible markup language) document.

The output document is an HTML (hypertext markup language) or PDF (portable document format) document.

The profiling tool is part of a document editing program and the marking tool is part of a document rendering program.

The document editing program is an XML (extensible markup language) text editor; and the document rendering program is an XSL (extensible stylesheet language) transformation program.

In another general aspect, the invention provides apparatus comprising:

means for receiving from a profiling tool a profiled document, the profiling tool being a tool that receives a source document and a readership profile and applies the readership profile to the source document to generate a profiled document, the readership profile specifying one or more target readerships, the source document including one or more portions of readership-specific content that is specific to a particular readership, the profiled document including only those portions of readership-specific content that is specific to any of the target readerships;

means for determining whether more than one target readership has been specified in the readership profile; and

means for, if more than one target readership has been specified, marking each portion of readership-specific content in the profiled document to identify the readership to which the content is specific, and if only one target readership has been specified, not marking any portion of readership-specific content in the profiled document.

Implementations can include one or more of the following features:

Associated with the profile document is an attachment that lists the portions of reader-specific content for each target readership specified in the readership profile. Means for determining whether more than one target readership has been specified in the readership profile includes means for using the attachment to make the determination.

Means for determining whether more than one target readership has been specified in the readership profile includes means for retrieving a log file generated by the profiling tool, the log file including information that identifies the target readerships specified in the readership profile, and using the log file to make the determination.

The profiled document is an XML (extensible markup language) document.

The output document is an HTML (hypertext markup language) or PDF (portable document format) document.

The invention can be implemented to realize one or more of the following advantages. The marking tool can determine the target readerships specified in the readership profile without having access to the readership profile.

One implementation of the invention provides all of the above advantages.

Details of one or more implementations of the invention are set forth in the accompanying drawings and in the description below. Further features, aspects, and advantages of the invention will become apparent from the description, the drawings, and the claims.

### BRIEF DESCRIPTION OF THE DRAWINGS

FIG. 1A illustrates a system that is one implementation of the invention.

FIG. 1B illustrates a method in accordance with one implementation of the invention.

FIG. 2 illustrates a source document.

FIG. 3 illustrates readership profiles, profiled documents, and output documents.

FIG. 4 illustrates profiled documents with associated attachments.

FIG. 5 illustrates a profiling tool that generates a log file.

FIG. 6 illustrates an XML implementation of the system.

Like reference numbers and designations in the various drawings indicate like elements.

### DETAILED DESCRIPTION

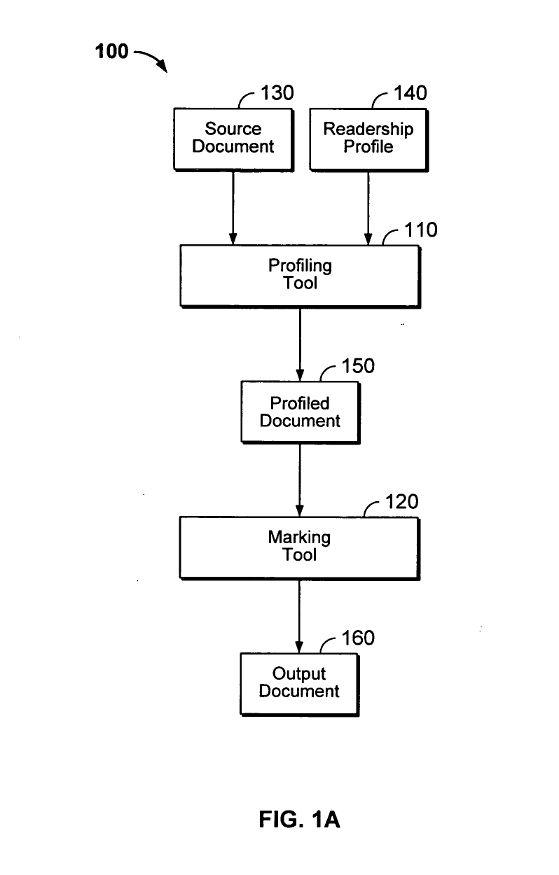

As illustrated in FIG. 1A, a system 100 includes a profiling tool 110 and a marking tool 120.

The profiling tool 110 receives a source document 130. The source document 130 is received from a document editing program. The profiling tool 110 can be a component of the document editing program, or alternatively, the profiling tool 110 can be a separate program from the document editing program.

The source document 130 includes one or more portions of readership-specific content. Each portion of readership-specific content is defined in the source document 130 as being specific to a particular readership. For example, each portion of readership-specific content can be tagged with data that specifies the readership for the portion. The readership-specific content can include content specific to different readerships. For example, a computer user manual can include content specific to Unix users and content specific to Windows users.

Optionally, the source document 130 can also include one or more portions of generic content that is not specific to a particular readership. The content (readership-specific or generic) can be any type of content, including textual, graphical, and audio or video content.

The profiling tool 110 also receives a readership profile 140. In one implementation, the profiling tool 110 receives the readership profile 140 from a user of the profiling tool 110. Alternatively, the readership profile 140 can be stored within the system 100 and retrieved by the profiling tool 110.

The readership profile 140 specifies one or more target readerships. The target readerships represent the target audience for the final rendered document that will be generated based on the source document 130.

The profiling tool 110 applies the readership profile 140 to the source document 130 to generate a profiled document 150. The profiled document 150 includes all the generic content in the source document 130 and only those portions of the readership-specific content in the source document 130 that are specific to any of the target readerships specified in the readership profile 140. The profiling tool 110 filters out any portions of the readership-specific content in the source document 130 that are not relevant to any of the target readerships specified in the readership profile 140.

The profiling tool 110 passes the profiled document 150 to the marking tool 120. The marking tool 120 prepares the profiled document 150 for rendering by a document rendering program. The marking tool 120 can be part of the document rendering program, or alternatively, can be a separate program.

The marking tool 120 generates an output document 160 from the profiled document 150. The output document 160 includes all the content contained in the profiled document 150, plus markings to distinguish between different kinds of readership-specific content. In one implementation, the marking tool 120 adds the markings only when more than one target readership has been specified in the readership profile.

As shown in FIG. 1B, the marking tool 120 determines whether more than one target readership has been specified in the readership profile (step 105). Different techniques for making this determination will be described below.

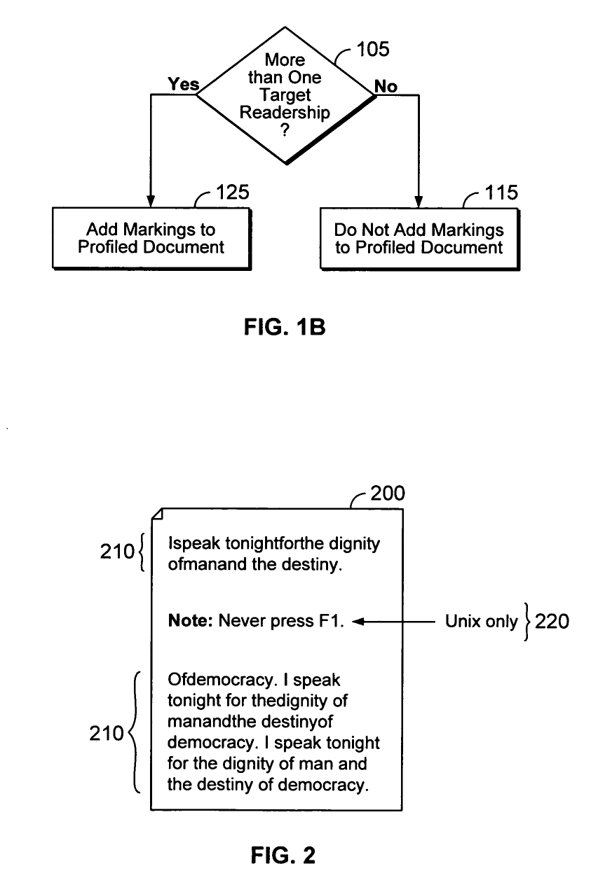

If only one target readership has been specified in the readership profile 140, then the marking tool 120 does not add any markings to the profiled document 150 because all the readership-specific content in the document is specific to the same readership (step 115). However, if more than one target readership has been specified, then the marking tool 120 adds markings to distinguish between the different kinds of readership-specific content (step 125), as illustrated in FIG. 2.

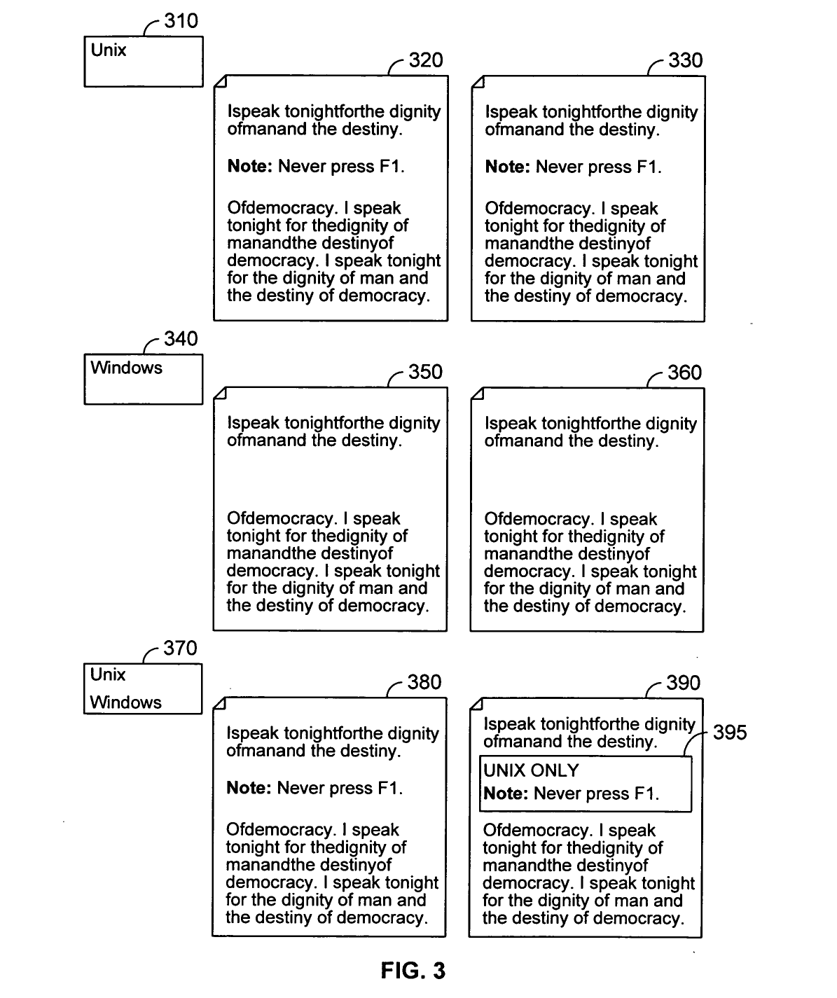

FIG. 2 shows an example 200 of a source document 130. The example source document 200 is a computer user manual. The computer user manual includes generic content 210 and reader-specific content 220 that is specific to readers that use the Unix operating system. FIG. 3 illustrates three different scenarios involving the example source document 200 of FIG. 2.

In the first scenario, the readership profile 310 for the example source document 200 specifies the target readership: Unix. The corresponding profile document 320 and output document 330 include the all the generic content 210 as well as the Unix-specific content 220.

In the second scenario, the readership profile 340 for the example source document 200 specifies the target readership: Windows. The corresponding profile document 350 and output document 360 include only the generic content 210, but not the Unix-specific content 220.

In the third scenario, the readership profile 370 for the example source document 200 specifies two target readerships: Unix and Windows. As in the first scenario, the corresponding profile document 380 and output document 390 include all the generic content 210 as well as the Unix-specific content 220. However, in contrast to the first scenario, where the output document 330 does not contain any markings for the Unix-specific content 220, in the third scenario, the output document 390 contains markings 395 identifying the Unix-specific content 220 as being Unix-specific content. The marking tool 120 adds the markings 395 only when more than one target readership is specified in the readership profile.

However, in some cases, the marking tool 120 may not have access to the readership profile. Thus, the marking tool 120 cannot use the readership profile 140 to determine which target readerships have been specified. In such cases, the marking tool 120 is unable to deduce the target readership by examining the profiled document 150 because the same profiled document 150 could have resulted from different readership profiles. For example, in the first scenario and the third scenario described above, the profiles 310, 370 are different, but the profiled documents 320, 380 are the same. Thus, having only the information from the profiled document, the marking tool 120 has incomplete information to determine whether or not the document needs to be marked.

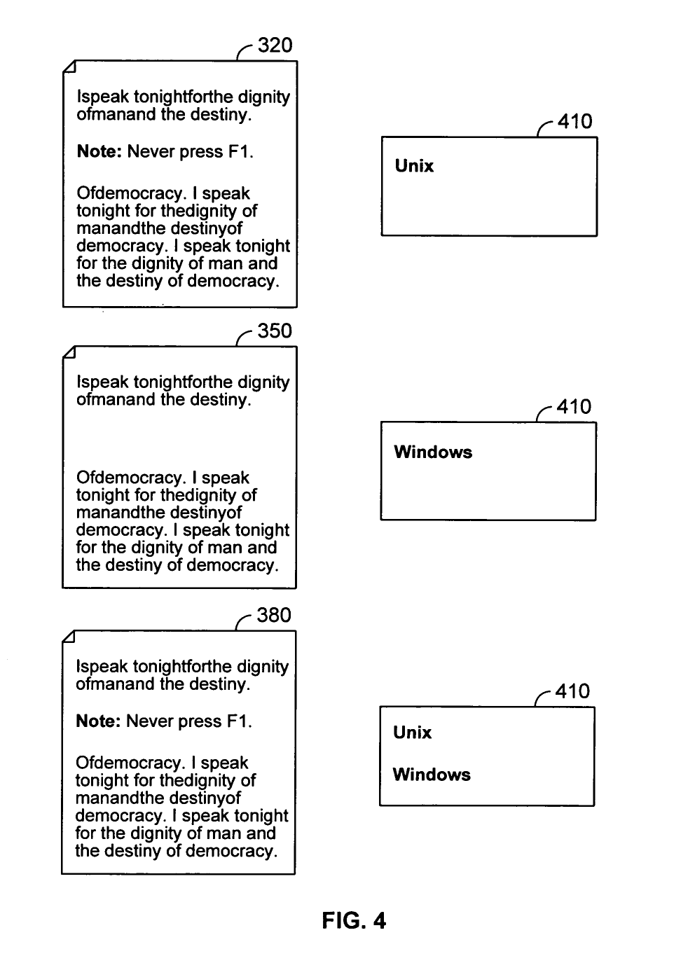

As illustrated in FIG. 4, one solution, described here with reference to the specific case described above with reference to FIG. 3, is to associate with each profiled document 320, 350, 380, an attachment 410 that lists each target readership specified in the readership profile. Thus, the content of the attachment 410 varies depending on which target readerships are specified in the readership profile. Using the attachment 410, the marking tool 120 can deduce whether more than one target readership has been specified.

The attachment 410 can be generated by applying the readership profile 140 to a control set. The control set initially contains all the possible target readerships that can be specified. After application of the readership profile 140 to the control set, the resulting control set contains only those target readerships that are specified in the readership profile 140. The resulting control set is then associated with the profiled document as an attachment 410 to the profiled document.

In one implementation, the control set is represented as a list of elements with attribute values. For example:
<paragraph profile=“Unix”>dummy text</paragraph>
<paragraph profile=“windows”>dummy text</paragraph>

When the profiling tool 110 applies the readership profile 140 to the control set, the profiling tool 110 examines the tags and removes those elements whose attribute value does not correspond to any of the specified target readerships.

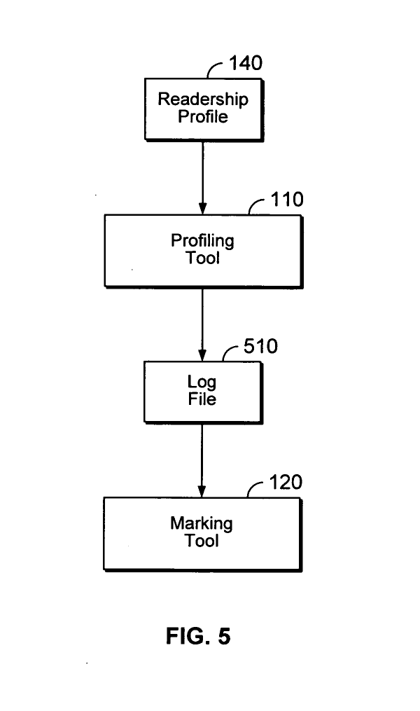

In an alternative solution, illustrated in FIG. 5, when the profiling tool 110 receives user input specifying the target readerships to be included in the profile 140, the profiling tool 110 records the specified target readerships separately in a log file 510 that is accessible to the marking tool 120. The marking tool 120 then uses the contents of the log file 510 to determine whether more than one target readership has been specified. Alternatively, instead of recording the specified target readerships in a log file 510, the profiling tool 110 can directly send the specified target readerships to the marking tool 120 as a separate input parameter to the marking tool 120.

The alternative solution requires the profiling tool 110 to generate the log file 510. The first solution does not require the profiling tool 110 to generate any additional data besides the profiled document 150. Instead, the first solution places the burden on the author of the source document 130 to generate the attachment 410.

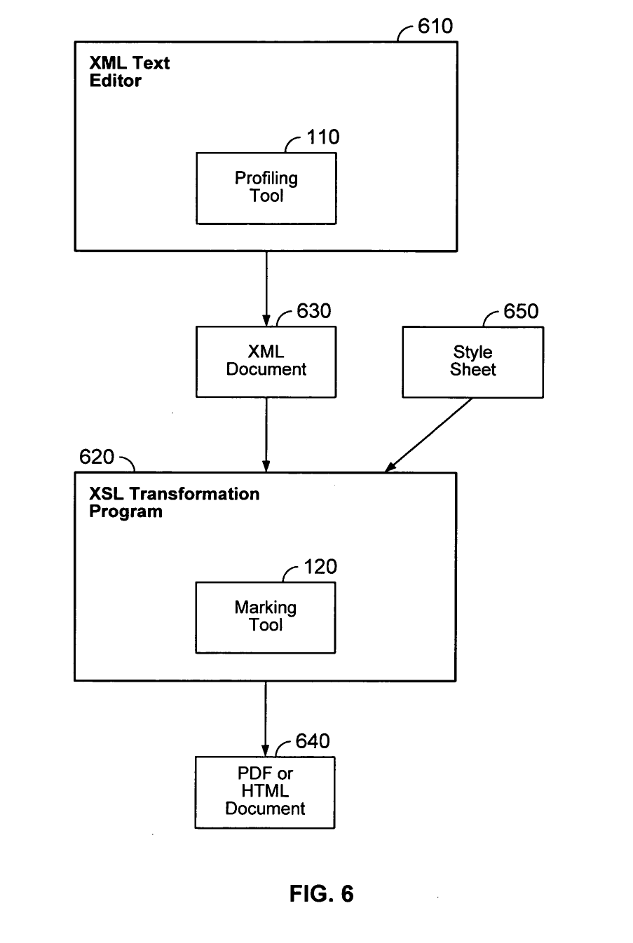

In one implementation, illustrated in FIG. 6, the profiling tool 110 is part of an XML (extensible markup language) text editor 610 and the marking tool 120 is part of an XSL (extensible stylesheet language) transformation program 620. The profiled document 130 generated by the XML text editor 610 is an XML document 630. The XSL transformation program 620 converts the XML document 630 into an HTML (hypertext markup language) or PDF (portable document format) document 640 by applying a style sheet 650 to the XML document 630. The XML text editor 610 and XSL transformation program 620 can be implemented using the Enterprise E-Content Engine (E3) technology developed by Arbortext Incorporated of Ann Arbor, Mich.

The invention has been described above in the context of determining the target readership of a document. However, one skilled in the art could apply the techniques of the invention in other contexts, as illustrated by the following description.

Consider a first mechanism that takes two inputs, a source set and selection set. A control set defines the elements that can be members of the source set and the selection set. The first mechanism outputs a results set that is generating by taking the source set and removing from the source set all members of the source set that also belong to the selection set.

Consider a second mechanism that needs to determine the contents of the selection set without having access to the selection set. Based on examining the source set and the results set, it may not be possible for the second mechanism to deduce the contents of the selection set. This is illustrated in the following example:

Assume a control set with four members: A, B, C, and D.

Assume a source set with three members: A, B, and C.

Assume a selection set with two members: C and D.

The resulting results set contains two members: A and B.

In this example, the results set differs from the source set by only one member, C. By examining only the source set and the results set, the second mechanism would incorrectly deduce that the selection set contains only a single member, C.

A solution in accordance with the invention is to provide the control set as input to the first mechanism. The first mechanism then applies the selection set to both the source set and the control set. In the example above, the first mechanism removes C and D from the control set. The resulting control set contains just A and B.

The second mechanism knows the contents of the original control set. Thus, by comparing the resulting control set {A, B} against the original control set {A, B, C, D}, the second mechanism correctly deduces that the selection set contains {C, D}.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component (e.g., a data server), a middleware component (e.g., an application server), or a front-end component (e.g., a client computer having a graphical user interface or a Web browser through which a user can interact with an implementation of the invention), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular implementations, but other implementations can be implemented and are within the scope of the following claims. For example, the operations of the invention can be performed in a different order and still achieve desirable results. In certain implementations, multitasking and parallel processing may be preferable. Other implementations are within the scope of the following claims

What is claimed is:

1. A system comprising:
a profiling tool that is operable to:
receive a source document and a readership profile, and
apply the readership profile to the source document to generate a profiled document, the readership profile specifying one or more target readerships, the source document including one or more portions of readership-specific content that is specific to a particular readership, the profiled document including only those portions of readership-specific content that is specific to any of the target readerships; and
a marking tool that is operable to:
receive the profiled document from the profiling tool,
determine whether more than one target readership has been specified in the readership profile; and
if more than one target readership has been specified, mark each portion of readership-specific content in the profiled document to identify the readership to which the content is specific, and if only one target readership has been specified, not mark any portion of readership-specific content in the profiled document.

2. The system of claim 1, wherein:
the profiling tool generates the profiled document by filtering out those portions of readership-specific content in the source document that are not specific to any of the target readerships specified in the readership profile.

3. The system of claim 1, wherein:
associated with the profiled document is an attachment that lists each target readership specified in the readership profile; and
the marking tool determines whether more than one target readership has been specified in the readership profile by using the attachment to make the determination.

4. The system of claim 1, wherein:
the marking tool determines whether more than one target readership has been specified in the readership profile by retrieving a log file generated by the profiling tool, the log file including information that identifies the target readerships specified in the readership profile, and using the log file to make the determination.

5. The system of claim 1, wherein:
the profiled document is an XML (extensible markup language) document.

6. The system of claim 1, wherein:
the output document is an HTML (hypertext markup language) or PDF (portable document format) document.

7. The system of claim 1, wherein:
the profiling tool is part of a document editing program; and
the marking tool is part of a document rendering program.

8. The system of claim 3, wherein:
the document editing program is an XML (extensible markup language) text editor; and
the document rendering program is an XSL (extensible stylesheet language) transformation program.

9. A computer program product, tangibly embodied in an information carrier, the computer program product being operable to cause data processing apparatus to perform operations comprising:
receiving a profiled document from a profiling tool, the profiling tool being a tool that receives a source document and a readership profile and applies the readership profile to the source document to generate a profiled document, the readership profile specifying one or more target readerships, the source document including one or more portions of readership-specific content that is specific to a particular readership, the profiled document including only those portions of readership-specific content that is specific to any of the target readerships specified in the readership profile;
determining whether more than one target readership has been specified in the readership profile; and
if more than one target readership has been specified, marking each portion of readership-specific content in the profiled document to identify the readership to which the content is specific, and if only one target readership has been specified, not marking any portion of readership-specific content in the profiled document.

10. The product of claim 9, wherein:
associated with the profile document is an attachment that lists each target readership specified in the readership profile; and
determining whether more than one target readership has been specified in the readership profile includes using the attachment to make the determination.

11. The product of claim 9, wherein:
determining whether more than one target readership has been specified in the readership profile includes retrieving a log file generated by the profiling tool, the log file including information that identifies the target readerships specified in the readership profile, and using the log file to make the determination.

12. The product of claim 9, wherein:
the profiled document is an XML (extensible markup language) document.

13. The product of claim 9, wherein:
the output document is an HTML (hypertext markup language) or PDF (portable document format) document.

14. The product of claim 9, wherein:
the profiling tool is part of a document editing program; and
the marking tool is part of a document rendering program.

15. The product of claim 12, wherein:
the document editing program is an XML (extensible markup language) text editor; and
the document rendering program is an XSL (extensible stylesheet language) transformation program.

16. Apparatus comprising:
means for receiving from a profiling tool a profiled document, the profiling tool being a tool that receives a source document and a readership profile and applies the readership profile to the source document to generate a profiled document, the readership profile specifying one or more target readerships, the source document including one or more portions of readership-specific content that is specific to a particular readership, the profiled document including only those portions of readership-specific content that is specific to any of the target readerships;
means for determining whether more than one target readership has been specified in the readership profile; and
means for, if more than one target readership has been specified, marking each portion of readership-specific content in the profiled document to identify the readership to which the content is specific, and if only one target readership has been specified, not marking any portion of readership-specific content in the profiled document.

17. The apparatus of claim 16, wherein:
associated with the profile document is an attachment that lists each target readership specified in the readership profile; and
means for determining whether more than one target readership has been specified in the readership profile includes means for using the attachment to make the determination.

18. The apparatus of claim 16, wherein:
means for determining whether more than one target readership has been specified in the readership profile includes means for retrieving a log file generated by the profiling tool, the log file including information that identifies the target readerships specified in the readership profile, and using the log file to make the determination.

19. The apparatus of claim 16, wherein:
the profiled document is an XML (extensible markup language) document.

20. The apparatus of claim 16, wherein:
the output document is an HTML (hypertext markup language) or PDF (portable document format) document.
